(19) United States
(12) Patent Application Publication
(10) Pub. No.: US 2025/0381934 A1
(43) Pub. Date: Dec. 18, 2025

(54) ACCESSORY ASSEMBLY STRUCTURE OF WINDSHIELD WIPER

(71) Applicant: DANYANG UPC AUTO PARTS CO., LTD., DANYANG (CN)

(72) Inventors: Che-Wei CHANG, New Taipei City (TW); Cheng-Kai YANG, New Taipei City (TW); Chuan-Chih CHANG, New Taipei City (TW)

(21) Appl. No.: 18/742,264

(22) Filed: Jun. 13, 2024

(51) Int. Cl. B60S 1/40; B60S 1/34

(52) U.S. Cl. CPC B60S 1/4048; B60S 1/3479; B60S 2001/4096

(57) ABSTRACT

An accessory assembly structure (1) includes a sliding cover (10), a driving arm (20) and an accessory piece (30). The sliding cover (10) includes a shell (11). The shell (11) includes a receiving slot (12), a plurality of blocking ribs (13) and a pair of stopping blocks (14). The driving arm (20) includes an arm body (21) and a cover (22). The cover (22) includes a plurality of sockets (23). The cover (22) is inserted in the receiving slot (12) to move relative to the sliding cover (10). The accessory piece (30) is mounted in the cover (22) and includes a plurality of latching blocks (31) and a pair of latching slots (32). Each latching block (31) includes an inclined top (311) and is positioned on the socket (23) along the inclined top (311).

### TECHNICAL FIELD

The technical field relates to a windshield wiper, and more particularly relates to an accessory assembly structure of a windshield wiper.

### DESCRIPTION OF RELATED ART

A windshield wiper is installed on the outside of the windshield and connected to the wiper arm of the car. The wiper arm drives the windshield wiper to swing repeatedly on the windshield, thereby scraping off rainwater, stains and other objects on the windshield.

Furthermore, the wiper arm of a windshield wiper is attached to the accessory seat, and metal springs and wiper blades are connected to the bottom of the accessory seat. Accordingly, the wiper arm drives the accessory seat and presses the metal springs and wiper blades to clean the windshield. Moreover, the aforementioned accessory seat and metal springs are assembled through a riveting process. However, this assembly process is cumbersome and time-consuming, and that leads to increase costs. Additionally, the metal springs or accessory seat are easily deformed during the riveting process, resulting in poor appearance and dimensions. Therefore, improvements are necessary.

In view of the above drawbacks, the inventor proposes this disclosure based on his expert knowledge and elaborate researches in order to solve the problems of related art.

### SUMMARY OF THE DISCLOSURE

One object of this disclosure is to provide an accessory assembly structure for a windshield wiper to simplify the assembly process, in which the accessory piece is securely combined with the accessory seat to prevent loosening, thereby providing a firm combination.

This disclosure is an accessory assembly structure includes a sliding cover, a driving arm and an accessory piece. The sliding cover includes a shell. The shell includes a receiving slot, a plurality of blocking ribs and a pair of stopping blocks located in the receiving slot. The driving arm includes an arm body and a cover connected to the arm body. The cover includes a plurality of sockets on two sides thereof. The cover is inserted in the receiving slot and configured to move relative to the sliding cover along the blocking ribs and the pair of stopping blocks. The accessory piece is mounted in the cover. The accessory piece includes a plurality of latching blocks and a pair of latching slots. Each latching block includes an inclined top and is positioned in the socket along the inclined top. The sliding cover is configured to move toward the arm body to make the pair of stopping blocks move into the pair of latching slots, and the sliding cover is positioned on the accessory piece through the pair of stopping blocks being engaging with the pair of latching slots.

In one embodiment of this disclosure, the accessory assembly structure further includes an accessory seat, and the accessory piece is attached to the accessory seat.

In one embodiment of this disclosure, the blocking ribs are disposed spacedly on the inner wall of the shell, and the pair of the stopping blocks are located at an opening of the receiving slot.

In one embodiment of this disclosure, the shell includes a slide rail located between the inner wall and each of the stopping blocks, and the slide rail includes a guiding ramp disposed on the end thereof facing the arm body.

In one embodiment of this disclosure, the cover includes a pair of side walls, and the cover is inserted in the receiving slot through each side wall moving along the guiding ramp and the slide rail.

In one embodiment of this disclosure, the accessory piece includes a pair of clearance slots communicating with the pair of latching slots. The sliding cover is configured to longitudinally move into the accessory piece through the pair of stopping blocks moving along the clearance slots and laterally move into the pair of latching slots.

In one embodiment of this disclosure, each latching block is a trapezoidal block, and each socket includes a positioning plane and a positioning slope corresponding to a shape of each latching block. One side plane of each latching block abuts against the positioning plane to make the inclined top abut against the positioning slope.

In one embodiment of this disclosure, the accessory piece includes a supporting plate connected to the pair of latching slots.

In one embodiment of this disclosure, each latching slot is defined by a U-shaped opening and a protrusion located on the top of the U-shaped opening, and the dimension of the U-shaped opening is corresponding to the shape of the stopping block. One side of each stopping block is blocked by each protrusion to be free from disengaging with the U-shaped opening.

In one embodiment of this disclosure, an elastic arm is located at the bottom of the U-shaped opening of each latching slot, and each elastic arm includes a chamfer at the end thereof facing the stopping block.

In comparison with the related art, the accessory assembly structure of a windshield wiper in this disclosure includes a plurality of blocking ribs and a pair of stopping blocks disposed on the sliding cover. The cover of the driving arm includes a plurality of sockets on two sides thereof. Furthermore, the accessory piece includes a plurality of latching blocks and a pair of latching slots, and each latching block includes an inclined top. Thus, each latching block is positioned in the sockets along the inclined top and embedded in the cover. Accordingly, when the sliding cover moves toward the driving arm, the stopping blocks moves into the slot, and the sliding cover is positioned on the accessory through the stopping blocks being engaged with the latching slots. Therefore, the accessory assembly structure of a windshield wiper is simplified, and the accessory piece is firmly connected to the accessory seat to prevent loosening.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts a perspective schematic view of the accessory assembly structure of a windshield wiper in this disclosure.

FIG. 2 depicts a perspective exploded schematic view of the accessory assembly structure of a windshield wiper in this disclosure.

FIG. 3 depicts a schematic view of the sliding cover combining with the driving arm in this disclosure.

FIG. 4 depicts a cross-sectional view of the combination of the sliding cover and the driving arm in this disclosure.

FIG. 5 depicts a schematic view of the driving arm combining with the accessory piece in this disclosure.

FIG. 6 depicts a cross-sectional view of the combination of the driving arm and the accessory piece in this disclosure.

FIG. 7 depicts a cross-sectional view of the accessory assembly structure of a windshield wiper in this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

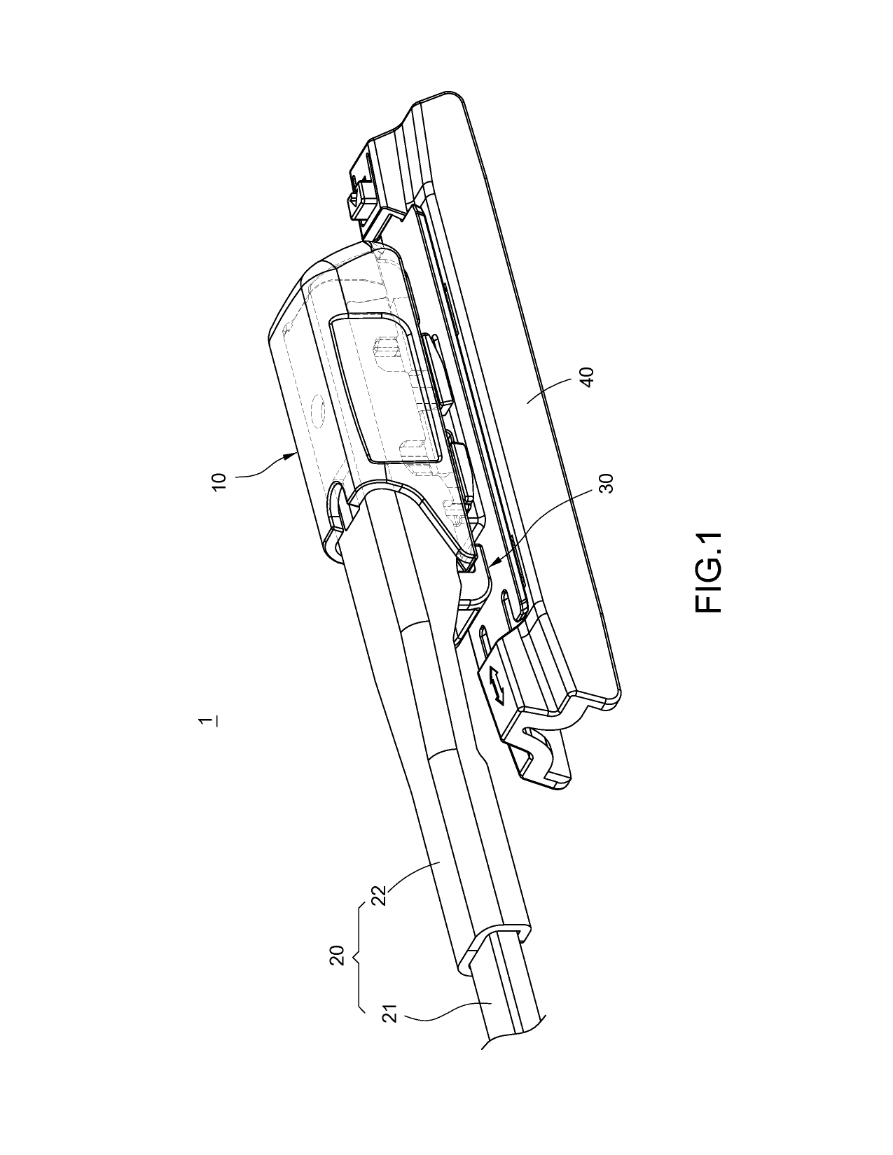

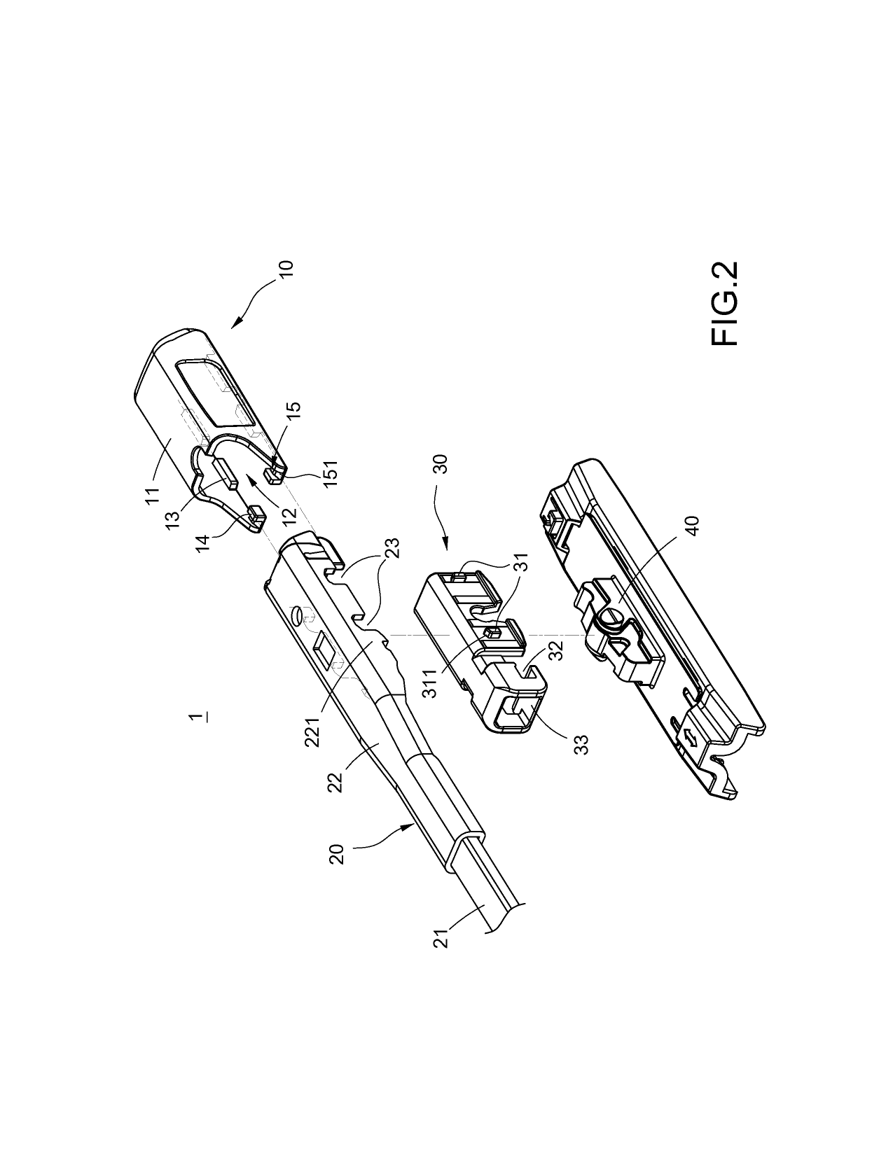

Please refer to FIG.1 and FIG. 2, which depict a perspective schematic view and a perspective exploded schematic view of the accessory assembly structure of a windshield wiper. The accessory assembly structure 1 in this disclosure includes a sliding cover 10, a driving arm 20, an accessory piece 30 and an accessory seat 40. The sliding cover 10 is slidably combined with the driving arm 20. The accessory piece 30 is embedded in the accessory seat 40. Additionally, the driving arm 20 is mounted on the accessory piece 30 and combined with the accessory piece 30 through the sliding cover 10 being engaged with the accessory piece 30 to complete the accessory assembly structure 1. More detailed descriptions of the accessory assembly structure 1 are as follows.

The sliding cover 10 includes a shell 11. The shell 11 includes a receiving slot 12, a plurality of blocking ribs 13 and a pair of stopping blocks 14 located in the receiving slot 12. The blocking ribs 13 are spaced apart from each other and located on the inner wall of the shell 11. The pair of the stopping blocks 14 are located at the opening of the receiving slot 12. Additionally, the shell 11 includes a slide rail 15 located between the inner wall and each of the stopping blocks 14.

The driving arm 20 includes an arm body 21 and a cover 22 connected to the arm body 21. The cover 22 includes a plurality of sockets 23 on two sides thereof. The cover 22 is inserted in the receiving slot 12 and configured to move relative to the sliding cover 10 along the blocking ribs 13 and the pair of stopping blocks 14. Moreover, the accessory piece 30 is mounted in the cover 22. The accessory piece 30 includes a plurality of latching blocks 31 and a pair of latching slots 32. In this embodiment, each latching block 31 is a trapezoidal block and includes an inclined top 311. The accessory piece 30 includes a supporting plate 33 connected to the pair of latching slots 32. The arrangement of the supporting plate 33 may increase the supporting force of the pair of latching slots 32.

In this embodiment, the sliding cover 10 includes a slide rail 15 on one side of the stopping block 14. On the other hand, the cover 22 includes a hook 24 on the rear side of the socket 23 (in the direction approaching the arm body 21). Additionally, the slide rail 15 includes a guiding ramp 151 on the outer end thereof facing the arm body 21. The cover 22 includes a pair of side walls 221, and the cover 22 is inserted into the receiving slot 12 through each side wall 221 moving along the guiding ramp 151 and the slide rail 15.

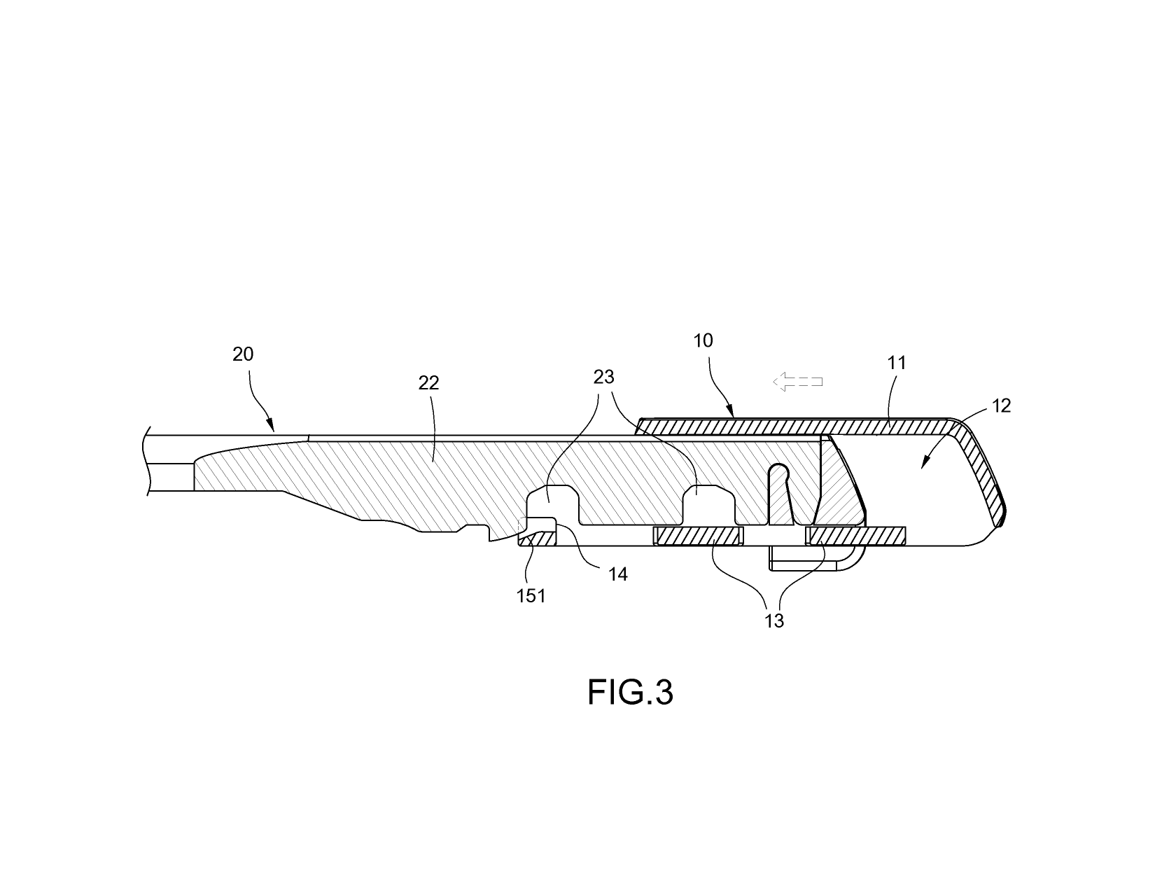

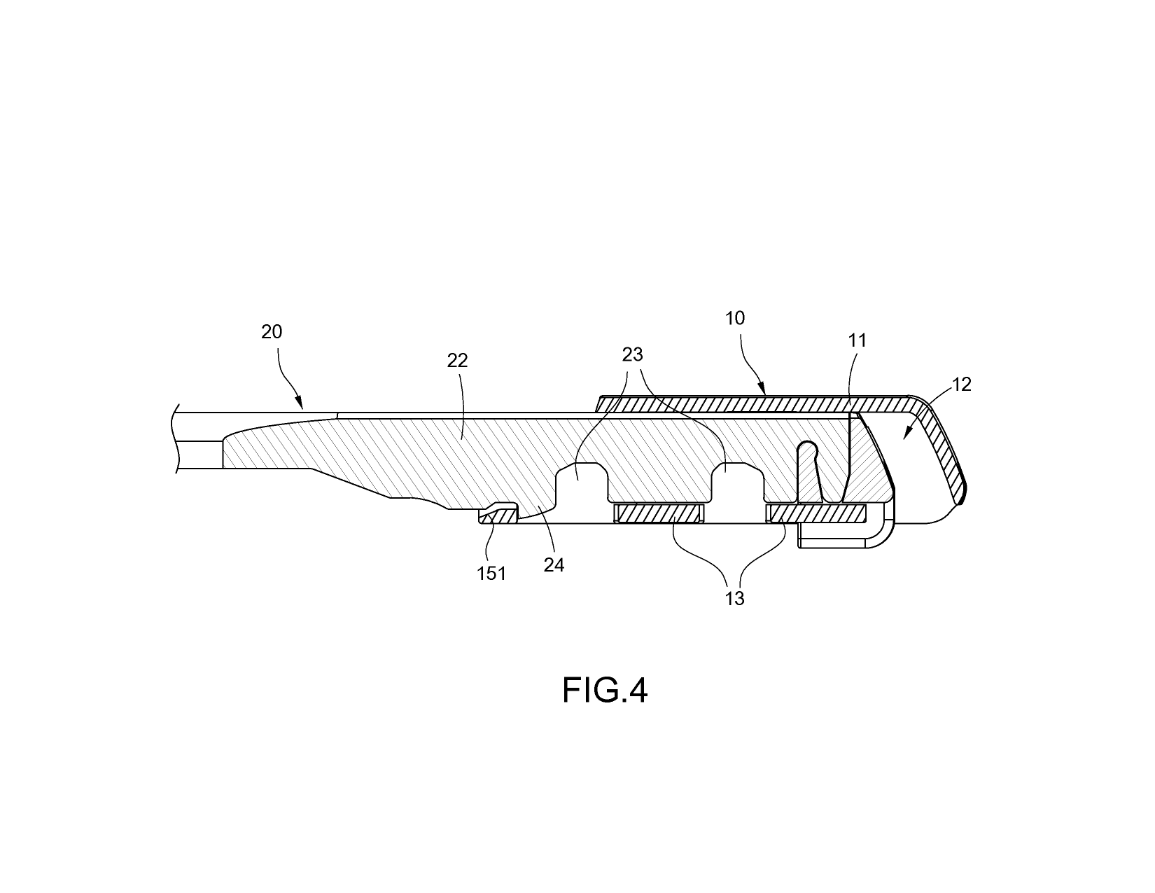

Please also refer to FIG. 3 and FIG. 4, which depict a schematic view of the sliding cover combining with the driving arm in this disclosure and a cross-sectional view of the combination of the sliding cove and the driving arm in this disclosure. The cover 22 of the driving arm 20 in this disclosure is inserted into the receiving slot 12 of the sliding cover 10. The cover 22 moves relative to the sliding cover 10 along the blocking ribs 13 and the pair of stopping blocks 14. It should be noted that after the sliding cover 10 is combined with the cover 22, the hook 24 may block the front side of the slide rail 15, preventing the sliding cover 10 from moving away from the arm body 21. However, it may still move in a direction closer to the arm body 21.

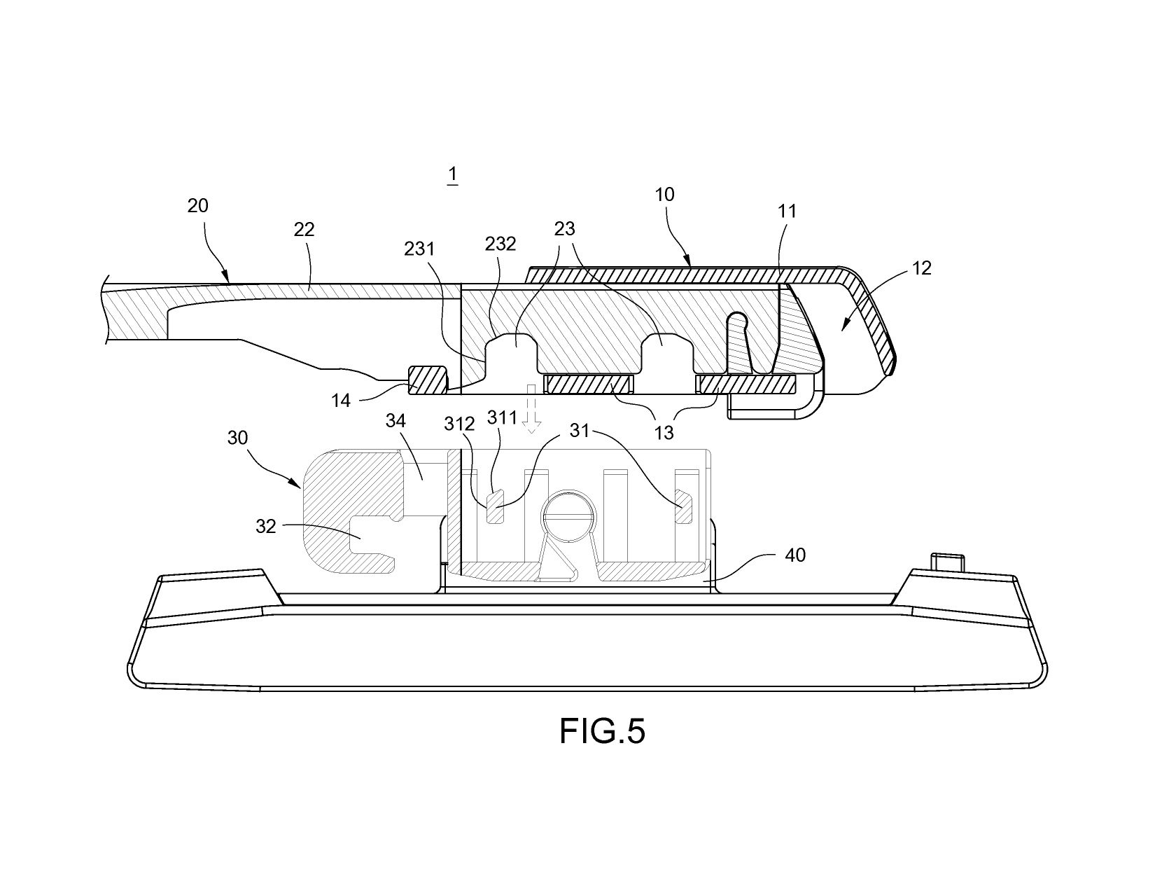

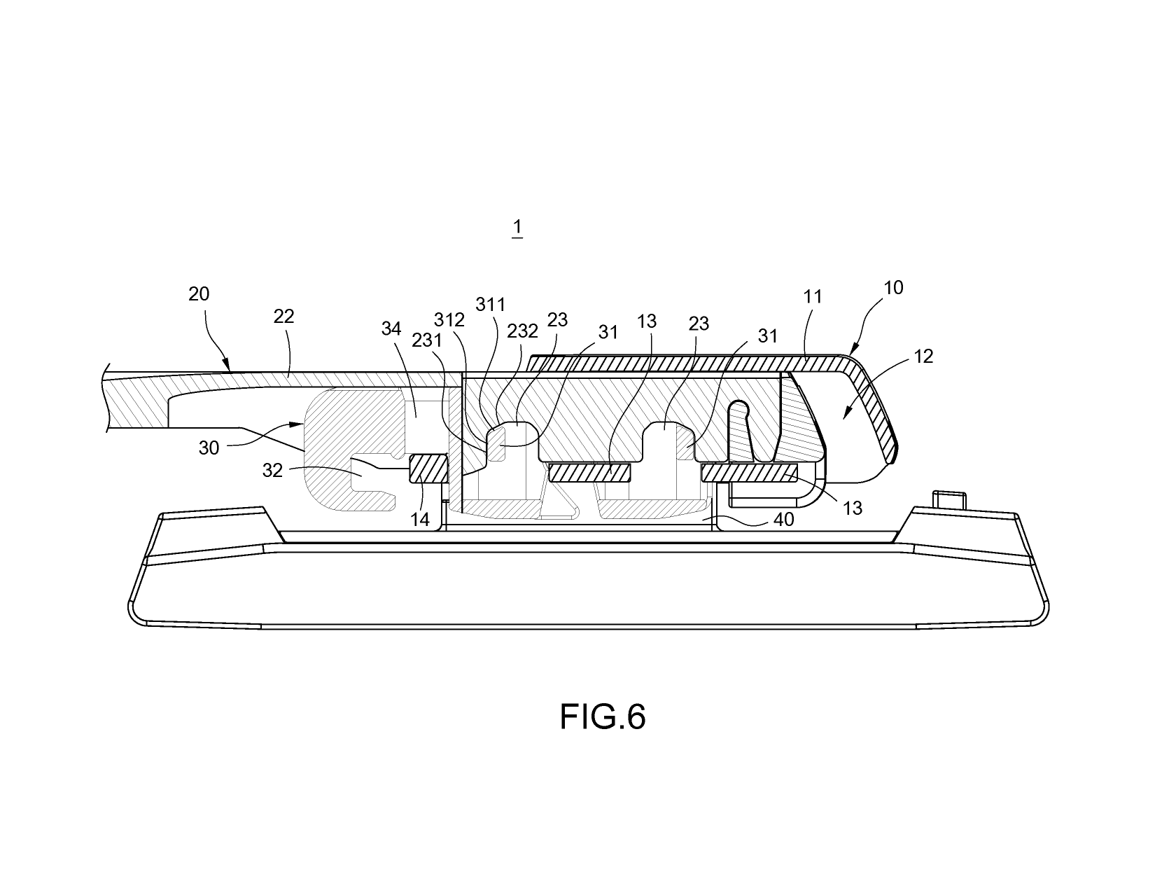

Please further refer to FIG. 5 and FIG. 6, which depict a schematic view of the driving arm combining with the accessory piece in this disclosure and a cross-sectional view of the combination of the driving arm and the accessory piece in this disclosure. After the sliding cover 10 is coupled to the driving arm 20, the driving arm 20 further moves toward the accessory piece 30 for assembly. The socket 23 of the driving arm 20 is aligned with the latching blocks 31 to make the driving arm 20 be mounted on the accessory piece 30. It is worth noticing that each socket 23 includes a positioning plane 231 and a positioning slope 232 corresponding to the shape of the latching block 31. Accordingly, one side plane 312 of each latching block 31 abuts against the positioning plane 231 to make the inclined top 311 abut against the positioning slope 232. That is, each latching block 31 is positioned in the socket 23 along the inclined top 311 and the side plane 312.

It should be noted that the accessory piece 30 includes a pair of clearance slots 34 communicating with the pair of latching slots 32. The sliding cover 10 longitudinally moves into the accessory piece 30 through the pair of stopping blocks 14 moving along the clearance slots 34.

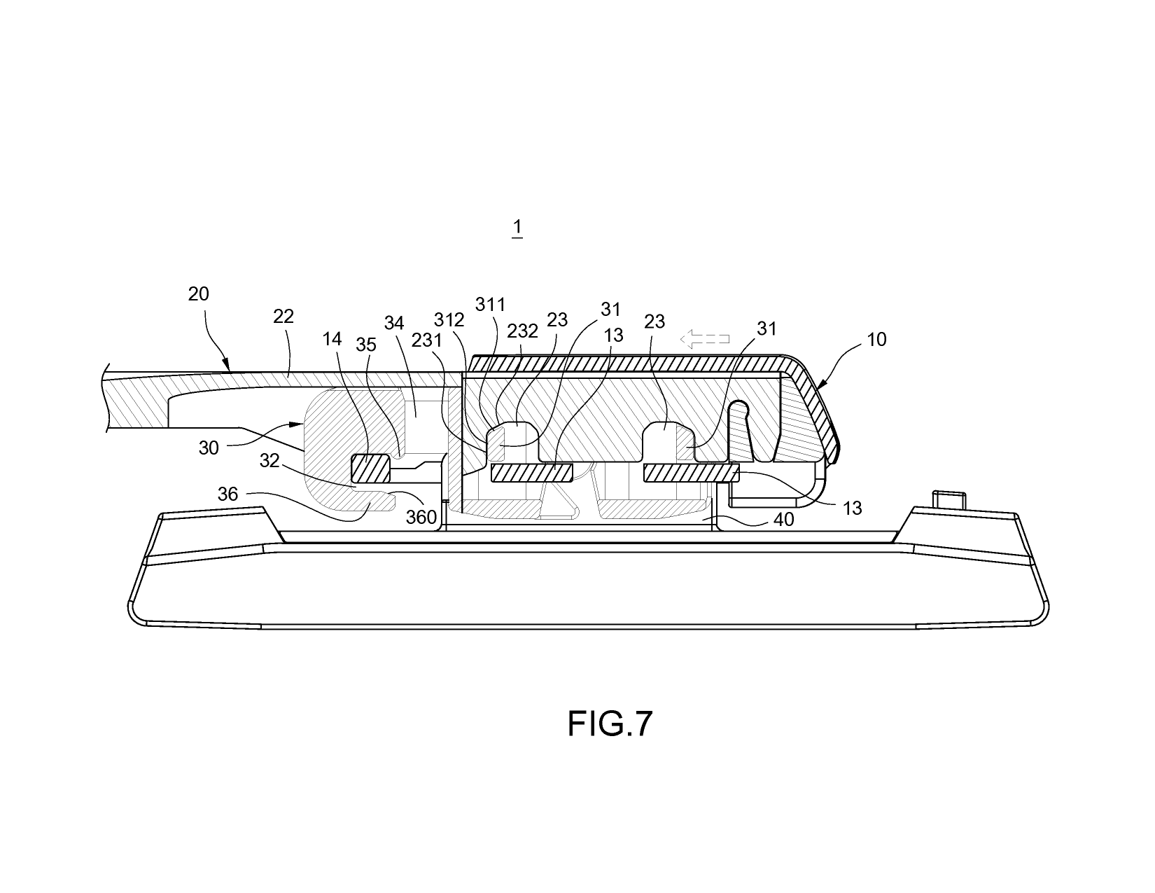

Please refer to FIG. 7, which depicts a cross-sectional view of the accessory assembly structure of a windshield wiper in this disclosure. The sliding cover 10 and the driving arm 20 longitudinally moves into the accessory piece 30, as shown in FIG. 5, and are positioned as shown in FIG. 6, and then the sliding cover 10 moves toward the arm body 21, so that the pair of stopping blocks 14 laterally moves into the pair of sockets 32. Accordingly, the sliding cover 10 is positioned on the accessory piece 30 through the pair of stopping blocks 14 being engaged in the pair of sockets 32. It is worth noting that the blocking ribs 13 in this disclosure are arranged spacedly corresponding to the sockets 23. When the sliding cover 10 is positioned on the accessory piece 30, the blocking ribs 13 may block one side of the latching blocks 31.

In this embodiment, each latching slot 32 is defined by a U-shaped opening and a protrusion 35 located on the top of the U-shaped opening. Additionally, the dimension of the U-shaped opening is corresponding to the shape of the stopping block 14, and one side of each stopping block 14 is blocked by each protrusion 35 to prevent disengaging from the U-shaped opening. Moreover, an elastic arm 36 is located at the bottom of the U-shaped opening of each latching slot 32, and each elastic arm 36 includes a chamfer 360 at the end thereof facing the stopping block 14. Accordingly, when the pair of stopping blocks 14 laterally move into the pair of sockets 32, they are initially pressed by the protrusion 35. Subsequently, as the stopping blocks 14 move, the elastic arm 36 deforms, thereby reducing the resistance for the stopping blocks 14 entering the sockets 32. Additionally, the chamfer 360 of the elastic arm 36 is disposed to facilitate the movement of the stopping blocks 14 into the sockets 32.

Therefore, the sliding cover 10, the driving arm 20 and the accessory piece 30 are locked with each other to prevent from being separated, thereby providing a firmly combination of the accessory assembly structure 1 of a windshield wiper.

While this disclosure has been described by means of specific embodiments, numerous modifications and variations could be made thereto by those skilled in the art without departing from the scope and spirit of this disclosure set forth in the claims.

1. An accessory assembly structure (1) of a windshield wiper, the accessory assembly structure (1) comprising:
a sliding cover (10), comprising a shell (11), the shell (11) comprising a receiving slot (12), a plurality of blocking ribs (13) and a pair of stopping blocks (14) located in the receiving slot (12);
a driving arm (20), comprising an arm body (21) and a cover (22) connected to the arm body (21), the cover (22) comprising a plurality of sockets (23) defined on two sides thereof, wherein the cover (22) is inserted in the receiving slot (12) and configured to move relative to the sliding cover (10) along the blocking ribs (13) and the pair of stopping blocks (14); and
an accessory piece (30), mounted in the cover (22), comprising a plurality of latching blocks (31) and a pair of latching slots (32), each latching block (31) comprising an inclined top (311) and positioned in each socket (23) along the inclined top (311);
wherein the sliding cover (10) is configured to move toward the arm body (21) to make the pair of stopping blocks (14) move into the pair of latching slots (32), and the sliding cover (10) is positioned on the accessory piece (30) through the pair of stopping blocks (14) being engaged with the pair of latching slots (32).

2. The accessory assembly structure (1) according to claim 1, further comprising an accessory seat (40), wherein the accessory piece (30) is attached to the accessory seat (40).

3. The accessory assembly structure (1) according to claim 1, wherein the blocking ribs (13) are disposed spacedly on an inner wall of the shell (11), and the pair of the stopping blocks (14) are located at an opening of the receiving slot (12).

4. The accessory assembly structure (1) according to claim 3, wherein the shell (11) comprises a slide rail (15) located between the inner wall and each stopping block (14), and the slide rail (15) comprises a guiding ramp (151) disposed on an end thereof facing the arm body (21).

5. The accessory assembly structure (1) according to claim 4, wherein the cover (22) comprises a pair of side walls (221), and the cover (22) is inserted in the receiving slot (12) through each side wall (221) moving along the guiding ramp (151) and the slide rail (15).

6. The accessory assembly structure (1) according to claim 1, wherein the accessory piece (30) comprises a pair of clearance slots (34) communicating with the pair of latching slots (32), and the sliding cover (10) is configured to longitudinally move into the accessory piece (30) through the pair of stopping blocks (14) moving along the clearance slots (34) and laterally move into the pair of latching slots (32).

7. The accessory assembly structure (1) according to claim 1, wherein each latching block (31) is a trapezoidal block, and each socket (23) comprises a positioning plane (231) and a positioning slope (232) corresponding to a shape of each latching block (31), and one side plane (312) of each latching block (31) abuts against the positioning plane (231) to make the inclined top (311) abut against the positioning slope (232).

8. The accessory assembly structure (1) according to claim 1, wherein the accessory piece (30) comprises a supporting plate (33) connected to the pair of latching slots (32).

9. The accessory assembly structure (1) according to claim 1, wherein each latching slot (32) is defined by a U-shaped opening and a protrusion (35) located on a top of the U-shaped opening, and a dimension of the U-shaped opening is corresponding to a shape of the stopping block (14), and one side of each stopping block (14) is blocked by each protrusion (35) to be free from disengaging with the U-shaped opening.

10. The accessory assembly structure (1) according to claim 9, wherein an elastic arm (36) is located at a bottom of the U-shaped opening of each latching slot (32), and each elastic arm (36) comprises a chamfer (360) located at an end thereof facing the stopping block (14).
